(19) United States
(12) Patent Application Publication
(10) Pub. No.: US 2008/0197984 A1
(43) Pub. Date: Aug. 21, 2008

(54) METHOD AND SYSTEM FOR REDUCING A PATRON'S WAITING TIME AT A WALK-IN FACILITY

(76) Inventors: David Michael Peters, Portland, MI (US); Kathleen Connell Peters, Portland, MI (US)

Correspondence Address: PAPARELLA & ASSOCIATES, PLC, 3878 CASCADE RD. SE, GRAND RAPIDS, MI, 49546, US

(21) Appl. No.: 11/767,472

(22) Filed: Jun. 22, 2007

Related U.S. Application Data
(60) Provisional application No. 60/890,070, filed on Feb. 15, 2007.

(51) Int. Cl. G08B 26/00

(52) U.S. Cl. 340/286.06

(57) ABSTRACT

A method for reducing a patron's waiting time at a walk-in facility includes providing a communications network, wherein the communications network includes a first communications link between a patron and a walk-in facility. The method includes providing a queue, receiving a consultation request via the first communications link, reserving a position in the queue in response to the consultation request, determining a time period before a consultation is available, and providing notice to the patron of the determined time period, wherein the patron may wait at a location other than the walk-in facility during the determined time period, thereby reducing the patron's need to wait at the walk-in facility before being consulted at the walk-in facility.

This application claims the benefit of the filing date of U.S. provisional application Ser. No. 60/890,070 entitled “Method for Reducing the Time a Patient Waits at an Urgent Care Facility” which was filed on Feb. 15, 2007 and which is herein incorporated by reference.

### BACKGROUND OF THE INVENTION

This invention relates to the operation and management of businesses and more particularly to a method and system of reducing a patron's need to wait at a walk-in facility in order to be consulted at the walk-in facility.

As used herein, businesses such as hospitals, pharmacies, salons, auto shops, accounting firms and other businesses that service clients on a walk-in basis may be considered walk-in facilities. And, while the methods and systems of this invention can be utilized in all types of walk-in facilities, one particularly suitable example is that of the urgent-care or walk-in health clinic. Of course, this is not meant to be limiting in any manner and these facilities may take on numerous configurations, and may be used for numerous purposes as is generally known within the art.

Typically, hospital business management systems include computer hardware and/or software for entering patient information and printing invoices. However, these business management systems typically only address administrative issues. Present health-care systems are not designed for the convenience of the patient: that is, the customer. Such health-care systems do not necessarily prioritize taking the patient's dignity, time, and convenience into consideration when operating a business management system. Rather, the existing business management systems are focused on keeping the medical staff and investments in hospitals and equipment efficiently utilized.

As such, appointment management software was developed for medical staff to manage a doctor's schedule, and other practice-based services. While some scheduling issues have been addressed by appointment management software, the health-care staff was traditionally left to their own efforts when it came to managing the ebb and flow of patients, and the staff had little control over how long a patient waits. And, with the need for health-care providers on the rise, the result is patients having to wait for longer periods at these facilities.

Attempting to address the needs of health-care providers, management systems were designed to control patient and employee flow, information flow, invoicing, maintenance, and the like. However, while these management systems may increase efficiency in the flow of patients already admitted into the care of the health facility, these systems do not address the waiting time of patients. Furthermore, many management systems utilize cumbersome software that often create inefficiencies. The present invention however takes a simpler approach and may be developed in a straightforward, uncomplicated manner.

To wit, when a patient goes to an urgent care facility (or any walk-in type of facility) they will typically wait for an extended period of time. For example, a patient waits to be seen by a physician. Even when the facility is not busy with other patients, the patient may still have to take the time to fill out the appropriate forms, and wait while their insurance information is submitted to and verified by the insurance provider. As such, regardless of when the patient arrives, the patient may spend a certain amount of time waiting at the facility before being seen by the physician.

In addition to addressing the time a patient spends idly waiting at an urgent care facility or other walk-in type facility, preventing further assault on the patient's health also warrants discussion. Contagions, particularly airborne contagions, are a known health risk in waiting rooms filled with the sick and ailing. Requiring patients to sit in close proximity to one another only serves to promote the spread of illnesses among those present. Significantly, with the appearance of new strains of drug-resistant contagions, preventing widespread infection is a serious concern of health-care facilities. Eliminating or reducing time spent in a health-care facility's waiting room eliminates or reduces an uninfected patient's exposure to these contagions, thereby guarding the patient's health against further assault, the result of which could be more debilitating or life-threatening than the patient's original health complaint. Furthermore, by reducing exposure of contagions to patients, the benefit of reduced exposure to the general population may also be appreciated.

Another issue that may arise with patients having to wait at an urgent care facility or other walk-in type facility is the anxiety or discomfort felt by some patients having to spend time in a waiting room. The discomfort may be severe, as in the case where a patient suffers from some form of psychological fear, such as agoraphobia (an abnormal fear public, open, or crowded places), mysophobia (an abnormal fear of germs, contamination, or dirt), and the like. In other cases, it would not be unusual for a patient to feel some level of anxiety from waiting in a populated area while dealing with the discomfort of their ailments or while grappling with a yet unanswered question of what the affliction is, and if a remedy is available. Some patients may also suffer from embarrassment and worry that others in the waiting room may discover the patient's ailment.

Similarly, in other types of walk-in facilities, such as pharmacies, salons, and automotive repair shops, and the like, patrons are commonly faced with having to wait at the facility before they are initially seen or serviced. As such, the patron is faced with waiting at the facility's physical location until a consultation or opening becomes available.

Accordingly, a need exists for novel systems and methods which have, among other advantages, the ability to reduce or eliminate a patron's wait at a walk-in facility. Therefore, a method and system that solves the aforementioned disadvantages and having the aforementioned advantages is desired.

### SUMMARY OF THE PRESENT INVENTION

The aforementioned drawbacks and disadvantages of traditional scheduling systems have been identified and a solution is set forth herein by the inventive business method for reducing a patron's waiting time at a walk-in facility wherein the method comprises providing a communications network including a first communications link between a patron and walk-in facility, providing a queue, and receiving a consultation request via the first communications link. A position is reserved in the queue in response to the consultation request, and a time period before a future available consultation is determined, after which notice of the determined time period is provided to the patron. Finally, the patron may wait at a location other than the walk-in facility during the determined time period, thereby reducing the patron's need to wait at the walk-in facility before being consulted at the walk-in facility.

Another aspect of the present invention includes a method for reducing a patron's waiting time at a walk-in facility wherein the method comprises providing a communications network including a first communications link between a patron and walk-in facility, providing a second communications link between the walk-in facility and a third-party entity, providing a queue, and receiving a consultation request via the first communications link. A position is reserved in the queue in response to the consultation request and a time period before a future available consultation is determined, after which notice of the determined time period is provided to the patron period. Finally, the patron may wait at a location other than the walk-in facility during the determined time period, thereby reducing the patron's need to wait at the walk-in facility before being consulted at the walk-in facility.

Yet another aspect of the present invention includes a method for eliminating a patron's waiting time at a walk-in health-care facility wherein the method comprises providing a communications network including an internet website, providing a second communications link between the walk-in health-care facility and a health-care insurance provider, providing a queue, and receiving a consultation request via the internet website. A position is reserved in the queue in response to the consultation request, and a time period before the next available consultation at the health-care facility is determined. The time period is determined such that the patron may report to the walk-in health-care facility at the expiration of the time period and be immediately consulted. After which, notice of the determined time period is provided to the patron. The inventive method further includes the steps of receiving patron information via the internet website, providing patron insurance information to the health-care insurance provider for verification via the second communications link, and receiving verification from the insurance provider via the second communications link. Finally, the patron may wait at a location other than the walk-in facility during the determined time period, thereby eliminating the patron's need to wait at the walk-in health-care facility before being consulted at the walk-in health-care facility.

Other objects, advantages, and features of the invention will become apparent upon consideration of the following detailed description, when taken in conjunction with the accompanying drawings. The above brief description sets forth rather broadly the more important features of the present disclosure so that the detailed description that follows may be better understood, and so that the present contributions to the art may be better appreciated. There are, of course, additional features of the disclosures that will be described hereinafter which will form the subject matter of the claims.

In this respect, before explaining the preferred embodiment of the disclosure in detail, it is to be understood that the disclosure is not limited in its application to the details of the construction and the arrangement set forth in the following description or illustrated in the drawings. To wit, the method and system for reducing a patron's need to wait at a walk-in facility of the present disclosure is capable of other embodiments and of being practiced and carried out in various ways. Also, it is to be understood that the phraseology and terminology employed herein are for description and not limitation. Where specific dimensional and material specifications have been included or omitted from the specification or the claims, or both, it is to be understood that the same are not to be incorporated into the claims.

As such, those skilled in the art will appreciate that the conception, upon which this disclosure is based, may readily be used as a basis for designing other structures, methods, and systems for carrying out the several purposes of the present invention. It is important, therefore, that the claims are regarded as including such equivalent constructions as far as they do not depart from the spirit and scope of the present invention.

Further, the purpose of the Abstract is to enable the U. S. Patent and Trademark Office and the public generally, and especially the scientists, engineers, and practioners in the art who are not familiar with the patent or legal terms of phraseology, to learn quickly, from a cursory inspection, the nature of the technical disclosure of the application. Accordingly, the Abstract is intended to define neither the invention nor the application, which is only measured by the claims, nor is it intended to be limiting as to the scope of the invention in any way.

These and other objects, along with the various features, and structures that characterize the invention, are pointed out with particularity in the claims annexed to and forming a part of this disclosure. For a better understanding of the method and system of the present disclosure, its advantages, and the specific objects attained by its uses, reference should be made to the accompanying drawings and descriptive matter in which there are illustrated and described the preferred embodiments of the invention.

As such, while embodiments of the method and system are herein illustrated and described, it is to be appreciated that various changes, rearrangements and modifications may be made therein, without departing from the scope of the invention as defined by the claims.

### BRIEF DESCRIPTION OF THE DRAWINGS

As a compliment to the description and for better understanding of the specification presented herein, eight pages of drawings are disclosed with an informative, but not limiting, intention.

FIG. 1 is a simplified entity relationship diagram embodying the present invention;

FIG. 2 is a simplified system configuration diagram embodying the invention;

FIG. 3 is another simplified system configuration diagram of another embodiment of the present invention;

FIG. 4 is another simplified entity relationship diagram of another embodiment of the present invention;

FIG. 5 is schematic flow chart illustrating a method according to the invention;

FIG. 6 is a schematic flow chart illustrating a method according to another embodiment of the invention;

FIG. 7 is a schematic flow chart illustrating a method according to yet another embodiment of the present invention; and

FIG. 8 is yet another simplified entity relationship diagram of another embodiment of the present invention.

### DETAILED DESCRIPTION OF THE PREFERRED EMBODIMENT

For purposes of description herein, one will understand that the invention may assume various alternative orientations and step sequences, except where expressly specified to the contrary. It is also to be understood that the specific devices and processes illustrated in the attached drawings and described in the following specification, are simply exemplary embodiments of the inventive concepts defined in the appended claims. Hence, specific quantifications and other physical characteristics relating to the embodiments disclosed herein are not to be considered as limiting, unless the claims expressly state otherwise.

The best mode for carrying out the invention is presented in terms of the preferred embodiment, wherein similar referenced characters designate corresponding features throughout the several figures of the drawings.

Reference will now be made in detail to the present preferred embodiments of the invention, examples of which are illustrated in the accompanying drawings. Wherever possible, these same referenced numerals will be used throughout the drawings to refer to the same or like parts. Like features between the various embodiments utilize similar numerical designations. Where appropriate, the various similar features have been further differentiated by an alphanumeric designation, wherein the corresponding alphabetic designator has been changed. Further, the dimensions illustrated in the drawings (if provided) are included for purposes of example only and are not intended to limit the scope of the present invention. Additionally, particular details in the drawings which are illustrated in hidden or dashed lines are to be considered as forming no part of the present invention.

As used herein, the term “walk-in facility” is meant to be used and defined in its general and ordinary sense. To wit, a walk-in facility generally refers to any facility that will service a patron or customer with little or no advance notice. This includes facilities that a patron may physically enter, but may also include other facilities, such as those that offer drive-thru service and those that offer remote service by internet, telephone, and the like. Of course, this is not meant to be limiting in any manner and these facilities may take on numerous configurations, and may be used for numerous purposes as is generally known within the art.

As used herein, the term “communications network” is meant to be used and defined in its general and ordinary sense. That is to say a communications network generally refers to a network of linked apparatuses arranged so that information may be passed from one part of the network to another. Further, information can be sent over telephone lines, cable lines, radio waves, satellites, or any other suitable medium. For example, the World Wide Web is a communications network comprising web servers that store and disseminate web pages, which are documents that contain information including text, graphics, animations, and videos to anyone with an internet connection. Of course, this is not meant to be limiting in any manner and a communications network may take on numerous configurations, and may be used for numerous purposes as is generally known within the art.

As used herein, the term “communications link” is meant to be used and defined in its general and ordinary sense. To wit, a communications link generally refers to the connection of one or more locations through various electronic devices and mediums for the purpose of transmitting and receiving information. Communications links can include user interfaces, such as an interactive website utilizing computer terminals and any suitable data transmission lines. For example, communications links may include telephones, facsimile devices, computers and the like, in addition to, or in lieu of user interfaces. Of course, this is not meant to be limiting in any manner and these communications links may take on numerous configurations, and may be used for numerous purposes as is generally known within the art.

As used herein, the term “queue” is meant to be used and defined in its general and ordinary sense. To wit, a queue generally refers to a group of people, data, or the like arranged in some ordered sequence. For example, a queue may be an ordered list of people or line of vehicles waiting to be served. Of course, this is not meant to be limiting in any manner and the queue may take on numerous configurations, and may be used for numerous purposes as is generally known within the art.

As used herein, the term “consultation” is meant to be used and defined in its general and ordinary sense. That is to say a consultation generally refers to a conference, between one or more other people, at which advice is given, or a service or product is provided. For example, a consultation can comprise an examination or interview by a doctor, nurse, physician's assistant, or the like. Other examples include: a patron seeking vehicle repair at an automotive repair shop; a patron seeking to fill a medication prescription at a pharmacy; a patron seeking accounting services; etc. This is not meant to be limiting in any manner, and these consultations may take on numerous configurations, and may be used for numerous purposes as is generally known within the art.

Typically, hospital business management systems include computer hardware and/or software for entering patient information and printing invoices. However, these business management systems typically only address administrative issues. Present health-care systems are not designed for the convenience of the patient: that is, the customer. Such health-care systems do not necessarily prioritize taking the patient's dignity, time, and convenience into consideration when operating a business management system. Rather, the existing business management systems are focused on keeping the medical staff and investments in hospitals and equipment efficiently utilized.

As such, appointment management software was developed for medical staff to manage a doctor's schedule, and other practice-based services. While some scheduling issues have been addressed by appointment management software, the health-care staff was traditionally left to their own efforts when it came to managing the ebb and flow of patients, and the staff had little control over how long a patient waits. And, with the need for health-care providers on the rise, the result is patients having to wait for longer periods at the facilities.

In an attempt to address the needs of health-care providers, management systems were designed to control patient and employee flow, information flow, invoicing, maintenance, and the like. However, while these management systems may increase efficiency in the flow of patients already scheduled for an appointment, or patients already admitted into the care of the health facility, these systems do not address the waiting time of patients. Furthermore, many management systems utilize cumbersome software that often create inefficiencies. The present invention however takes a simpler approach and may be developed in a straightforward, uncomplicated manner.

To wit, when a patient goes to an urgent care facility (or any walk-in type of facility) they will typically wait for an extended period of time. For example, a patient waits to be seen by a physician. Even when the facility is not busy with other patients, the patient may still have to take the time to fill out the appropriate forms, and wait while their insurance information is submitted to and verified by the insurance provider. As such, regardless of when the patient arrives, the patient may spend a certain amount of time waiting at the facility before being seen by the physician.

In addition to addressing the time a patient spends idly waiting at an urgent care facility or other walk-in type facility, preventing further assault on the patient's health also warrants discussion. Contagions, particularly airborne contagions, are a known health risk in waiting rooms filled with the sick and ailing. Requiring patients to sit in close proximity to one another only serves to promote the spread of illnesses among those present. Significantly, with the appearance of new strains of drug-resistant contagions, preventing widespread infection is a serious concern of health-care facilities. Eliminating or reducing time spent in a health-care facility's waiting room eliminates or reduces an uninfected patient's exposure to these contagions, thereby guarding the patient's health against further assault, the result of which could be more debilitating or life-threatening than the patient's original health complaint. Furthermore, by reducing exposure of contagions to patients, the benefit of reduced exposure to the general population may also be appreciated.

Another issue that may arise with patients having to wait at an urgent care facility or other walk-in type facility is the anxiety or discomfort felt by some patients having to spend time in a waiting room. The discomfort may be severe, as in the case where a patient suffers from some form of psychological fear, such as agoraphobia (an abnormal fear public, open, or crowded places), mysophobia (an abnormal fear of germs, contamination, or dirt), and the like. In other cases, it would not be unusual for a patient to feel some level of anxiety from waiting in a populated area while dealing with the discomfort of their ailments or while grappling with a yet unanswered question of what the affliction is, and if a remedy is available. Some patients may also suffer from embarrassment and worry that others in the waiting room may discover the patient's ailment.

Similarly, in other types of walk-in facilities, such as pharmacies, salons, and automotive repair shops, and the like, patrons are commonly faced with having to wait at the facility before they are initially seen or serviced. As such, the patron is faced with waiting at the facility's physical location until a consultation or opening becomes available.

Accordingly, a need exists for a novel system and method which have, among other advantages; the ability to reduce or eliminate a patron's waiting time at a walk-in facility. A method and system that solves the aforementioned disadvantages and having the aforementioned advantages is disclosed herein.

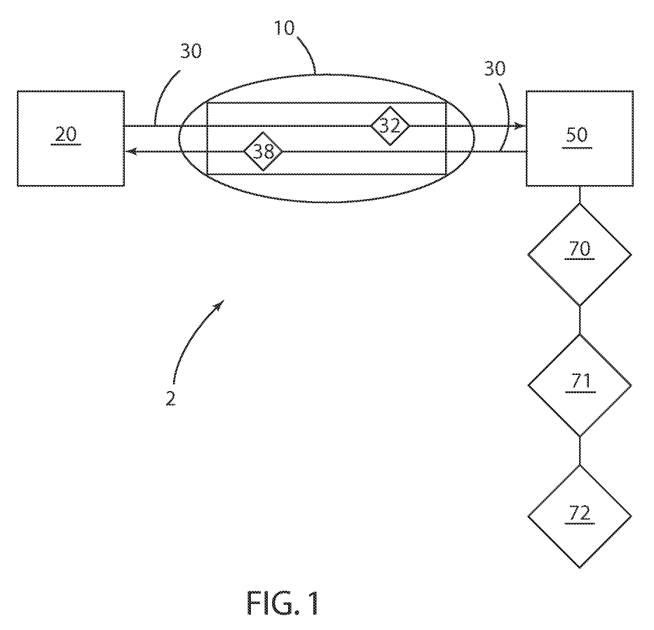

FIGS. 1-4 and FIG. 8 generally illustrate system entity-relationship diagrams and system configuration diagrams, each embodying various aspects of the present invention. More particularly, the figures illustrate a system and a method that are suitable for reducing a patron's waiting time at a walk-in facility. In this regard, the patron communicates with the walk-in facility, but does not have to physically enter the walk-in facility to reserve the patron's position in a queue. The disadvantages and drawbacks of the prior art are overcome through the method and system of the present invention.

Referring now to FIG. 1, there is shown a method of reducing a patron's waiting time at a walk-in facility, the method 2 comprising: providing a communications network 10, wherein the communications network 10 includes: a first communications link 30 between a patron 20 and a walk-in facility 50; providing a queue 70; receiving a consultation request 32, via the first communications link 30 ; reserving a position 71 in the queue 70 in response to the consultation request 32; determining a time period 72 before a future consultation is available; providing notice 38 to the patron 20 of the determined time period 72; wherein the patron 20 may wait at a location other than the walk-in facility 50 during the determined time period 72, thereby reducing the patron 20's need to wait at the walk-in facility 50 before being consulted at the walk-in facility 50.

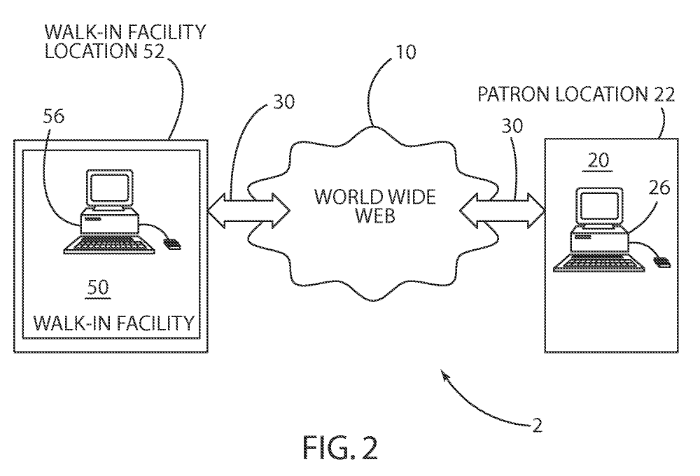

For purposes of the present invention, as seen in FIG. 2, communications network 10 comprises a connection of one or more devices, such as a patron terminal 26 and a walk-in facility terminal 56, via one or more communications links such as first communications link 30. For example, communications network 10 may be a land-based telephone network, a conventional LAN network environment, the Internet, or any other suitable network. Of course, this is not meant to be limiting in any manner and communications network 10 may take on numerous configurations, and may be used for numerous purposes as is generally known within the art.

First communications link 30 generally refers to the connection of one or more locations through various electronic devices and mediums, such as a walk-in facility location 52 and a patron location 22, for the purpose of transmitting and receiving information. For example, internet websites, telephone lines, and the like, can serve as first communications link 30. Of course, this is not meant to be limiting in any manner and first communications link 30 may take on numerous configurations, and may be used for numerous purposes as is generally known within the art.

Generally, to access an internet website, a terminal, such as patron terminal 26, is used. Of course, those skilled in the art will recognize that a wide variety of terminals may be utilized for a terminal. For example, Windows NT®-based terminals, UNIX®-based terminals, Apple Macintosh® terminals, Palm®-based handheld terminals, and other handheld terminals running other operating systems, may be particularly useful. Of course, this is not meant to be limiting in any manner and terminals may take on numerous configurations, and may be used for numerous purposes as is generally known within the art.

Patron 20 comprises a person seeking a service or product from a business, company, or the like. Patron location 22 may be patron 20's home, place of work, or any location other than walk-in facility location 52. Of course, this is not meant to be limiting in any manner and patron location 22 may comprise any location, including the walk-in health facility location 52.

Walk-in facility 50 comprises a business, company, or the like that will serve patron 20 with little or no advance notice. For example, an urgent-care facility may typically allow patients to “walk-in” and immediately request medical consultation (no notice), and may also provide the option of same-day appointments (little notice). Multitudes of other facilities, such as hospitals, auto repair shops, salons, etc., may also provide some form of walk-in service, and can be considered walk-in facility 50 for the purpose of this invention.

Queue 70 generally refers to a group of people, data, or the like arranged in some ordered sequence. For example, queue 70 may be a list of waiting patrons arranged by oldest request for consultation to newest request for consultation. This list may include patrons who have physically arrived at walk-in facility 50, as well as patrons who have requested consultation via some communications link 30, such as via telephone, fax, an internet website, or the like. Reserving position 71 in queue 70 generally involves inserting a person, data, or the like into a particular location in queue 70. For example, position 71 for patron 20 may be reserved at the end of queue 70 of prior listed patrons. Of course, this is not meant to be limiting in any manner, and reserving position 71 in queue 70 may take on numerous configurations as is generally known within the art.

Consultation request 32 generally refers to a request for conference, between one or more other people, at which advice is given, or a service or product is provided. For example, patron 20 may make consultation request 32 for service at walk-in facility 50 such as a health-care facility, an automotive repair shop, a pharmacy, a salon, and the like. Of course, this is not meant to be limiting in any manner and consultation request 32 may take on numerous configurations, and may be used for numerous purposes as is generally known within the art.

Time period 72 generally refers to an interval of time characterized by the occurrence of a certain condition, event, or phenomenon. For example, in the case of patron 20 waiting for a consultation, time period 72 elapses between consultation request 32 and the actual consultation.

Notice 38 generally refers to a communication of information. In the example of the inventive method, notice 38 may comprise information such as, time period 72 before a consultation is available. Of course, this is not meant to be limiting in any manner, and notice 38 may take on numerous configurations, and may be used for numerous purposes as is generally known within the art.

In one embodiment, as shown in FIG. 2, the World Wide Web serves as communications network 10. Patron 20 is a patient seeking a doctor's consultation at urgent health-care facility 50. Patient 20 may request consultation from patient location 22, i.e., any location, such as patient 20's home, workplace, and the like, wherein patient 20 has access to a computer terminal 26 that is capable of accessing World Wide Web 10. Patient 20 utilizes computer terminal 26 to connect to first communications link 30, the internet website of health-care facility 50. Website 30 may, for example, include an online input form, or the like, that allows patient 20 to request a future available consultation. Of course, this is not meant to be limiting in any manner and website 30 may take on numerous configurations, and may be used for numerous purposes as is generally known within the art.

Referring back to FIG. 1, once health-care facility 50 receives consultation request 32, for example via internet website 30, health-care facility 50 reserves position 71 in queue 70. At walk-in health-care facility 50, queue 70 typically may be provided when health-care facility 50 first opens for business each day. Health-care facilities that allow or require traditional appointments (consultations that occur on a later day than when the request was made) may initially provide queue 70, then modify queue 70 from thereon. Queue 70 is typically modified as various patients submit consultation requests 32, via internet website 30, other communications links, or at health-care facility 50. If there are no patients waiting for consultation, queue 70 simply remains empty until a new consultation request 32 is submitted.

Health-care facility 50 determines time period 72 before a consultation is available for patient 20. Time period 72 comprises, for example, the time lapse between consultation request 32 and the actual consultation. This determination may be arrived at by any available method as is known in the art and may include systems and methods for determining and calculating time period 72. For example, the determination may be performed by software designed to account for changing variables in health-facility's 50 resources, the doctors' and nurses' schedules, and the like.

Once time period 72 has been determined, health-care facility 50 provides notice 38 to patient 20 of the determined time period 72, for example, via internet website 30. Notice 38 may comprise any notification method. For example only, notice 38 may be provided via an interactive website 30 that patient 20 uses to make consultation request 32. Patient 20 may then wait at patient location 22, a location other than health-care facility 50 during the determined time period 72, thereby reducing patient 20's need to wait at health-care facility 50 before being consulted at health-care facility 50. For example, patient 20 may wait at home for the determined time period 72 to at least partially elapse, whereby patient 20 may report to health-care facility 50 at such a time so as to be immediately seen without the need to wait. Hence, patient 20 may see to his or her other duties and not spend needless time simply waiting to be seen at health-care facility 50, for example, waiting in the waiting room to be seen by a doctor.

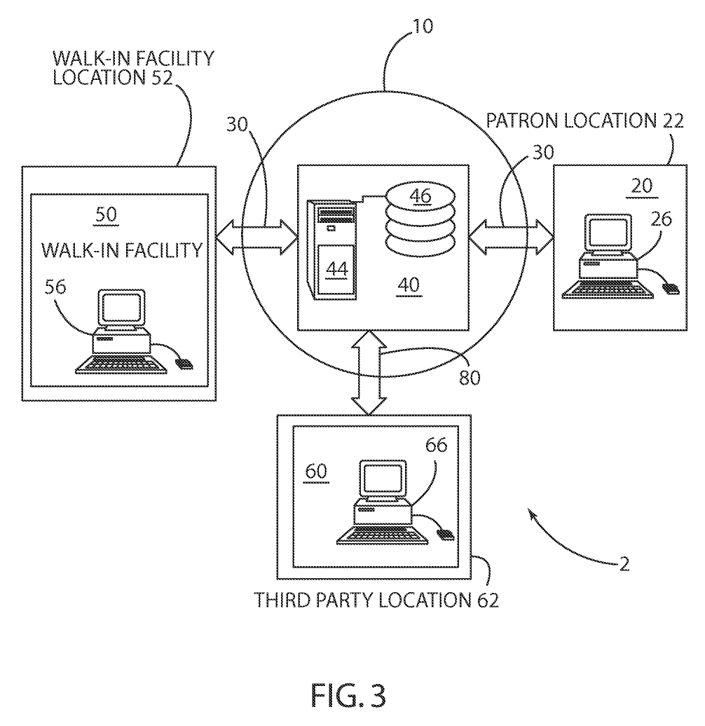

In another embodiment, as shown in FIG. 3, walk-in facility 50 may utilize a system 40. In one embodiment, system 40 comprises at least one computer 44 and an electronic database 46 for storing information. As is well known in the art, system 40 may be used to process information and/or may act as a server, i.e., a computer that provides information to client machines. Of course, it should be understood that communications network 10 does not require system 40 and may comprise any apparatus or person capable of: providing queue 70 of patrons; receiving consultation request 32 via first communications link 30, such as a telephone line; reserving position 71 in queue 70 in response to consultation request 32; determining a time period 72 before a future consultation is available; and providing notice 38 to patron 20 of the determined time period 72. The determination of time period 72 may be arrived at in any manner known in the art and may include, for example, systems and method for determining and calculating this time period. For example, time period 72 can be determined by applying historical data pertaining to the length of time consultations have lasted and the time needed for documentation and record keeping after the consultation.

It should be understood that if walk-in facility 50 utilizes system 40, it may reside in the same physical location (i.e., the same office) as walk-in facility 50 at walk-in facility location 52 and may be regarded as part of walk-in facility 50. Alternatively, system 40 may be located remotely from walk-in facility 50, since system 40 may be connected to walk-in facility 50 via first communications link 30.

As Shown in FIG. 3, in another embodiment of the present invention, the inventive method may also include a second communications link 80 via which a third-party entity 60 may communicate with walk-in facility 50. Third-party entity 60 may be any appropriate party other than walk-in facility 50 or patron 20. For example, third-party entity 60 may be a billing service or an insurance provider. Third-party entity 60 may be equipped with a third-party terminal 66 for connecting to, for example, walk-in facility 50, via second communications link 80, such as an internet website. Alternatively, second communications link 80, for example, between third-party entity 60 and walk-in facility 50 may be provided by traditional means including telephone, facsimile, computer, and the like, in addition to, or in lieu of an internet website.

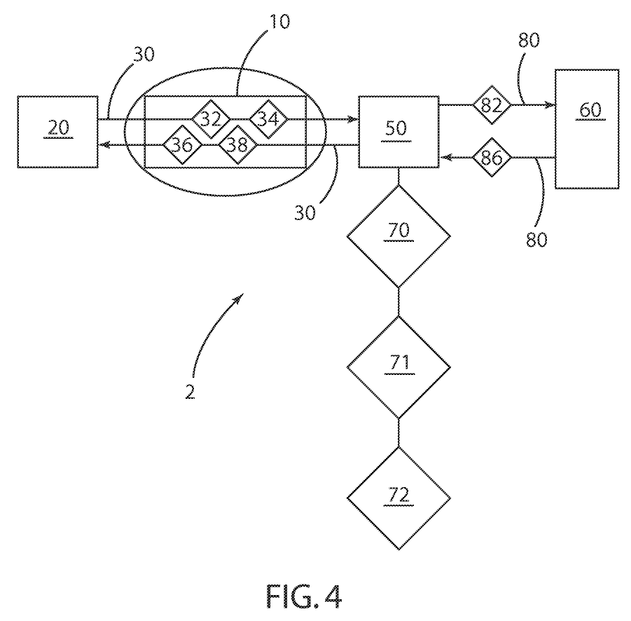

Referring now to FIG. 4, in one embodiment, walk-in facility 50 may receive patron information 34 via first communications link 30. Patron information 34 may include any suitable information communicated by patron 20 to walk-in facility 50. For example, age, weight, height, prior health conditions, family history, current medications, insurance information, and the like, may be communicated by patron 20 to walk-in facility 50. Of course, this is not meant to be limiting in any manner and patron information 34 may take on numerous configurations, and may be used for numerous purposes as is generally known within the art.

Generally, patron 20 may receive some response, such as instructions 36, from walk-in facility 50. Instructions 36 may be provided from walk-in facility 50 to patron 20 and may comprise any suitable information communicated from walk-in facility 50 to patron 20. For example, in the situation wherein walk-in facility 50 is a health-care facility, instructions 36 may include basic reminders to bring medication information, insurance information, and the like. If patron information 34 is provided and indicates a critical or emergency situation, walk-in facility 50 may provide instructions 36 to advise patron 20 to report immediately to walk-in facility 50, to contact an emergency services provider, or directions for stabilizing an injury until patron 20 arrives at walk-in facility 50. Of course, this is not meant to be limiting in any manner and instructions 36 may take on numerous configurations, and may be used for numerous purposes as is generally known within the art.

Other types of walk-in facilities 50, such as an automotive repair shop, may provide instructions 36 suited to that business. For example, instructions 36 may include: where to park the vehicle, which repair records to bring, an overview of the general repair process, and the like. This is not meant to be limiting in any manner, and instructions 36 may take on numerous configurations, and may be used for numerous purposes as is generally known within the art.

Walk-in facility 50 may provide patron's information 34 to third party entity 60 with a verification request 82 via second communications link 80. Verification 86 involves the act of reviewing, inspecting, testing, checking, auditing, or otherwise establishing and documenting whether items, processes, services, or documents conform to specified requirements. Verification 86, for example, may also include the process of pre-authorization. In the health-care field, pre-authorization typically involves the insurance provider reviewing and acknowledging that the insurance policy covers a medical treatment, dental treatment or hospitalization prior to the services being performed. Pre-authorization, in other fields, may be a similar process involving other insurance providers, such as an automobile insurance provider. Walk-in facility 50 may then receive verification 86 from third-party entity 60, via second communications link 80.

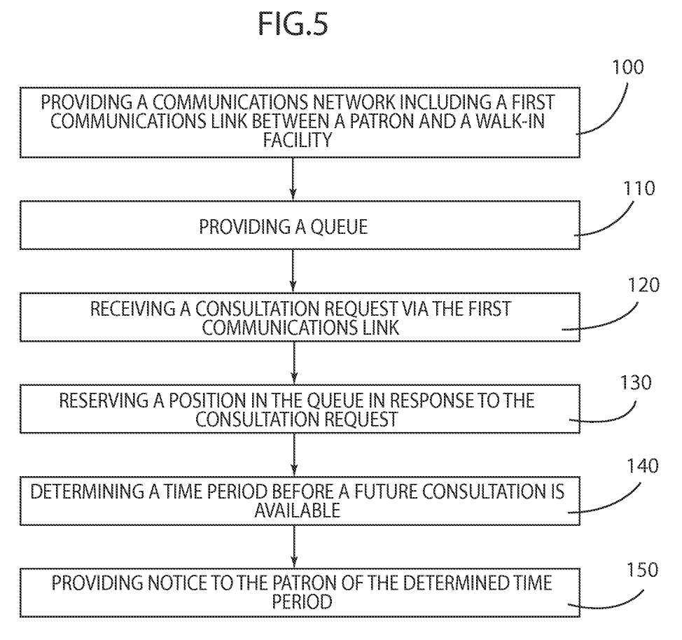

As shown in FIG. 5, one embodiment of the inventive method comprises providing communications network 10 including first communications link 30 between patron 20 and walk-in facility 50 (step 100). Queue 70 is provided (step 110). Upon receiving consultation request 32 via first communications link 30 (step 120), position 71 in queue 70 is reserved (step 130), the time period 72 before an available future consultation is determined (step 140), and patron 20 is provided notice 38 of the determined time period 72 (step 150). Step 150 may be performed by utilizing first communications link 30, or by other suitable communication links. For example, if patron 20 makes a consultation request 32 via internet website 30, patron 20 may be provided notice 38 of the determined time period 72 via internet website 30, or via telephone in lieu of, or in addition to, internet website 30. Patron 20 may wait then at a location other than walk-in facility 50 during determined time period 72, thereby reducing patron 20's need to wait at walk-in facility 50 before being consulted at walk-in facility 50.

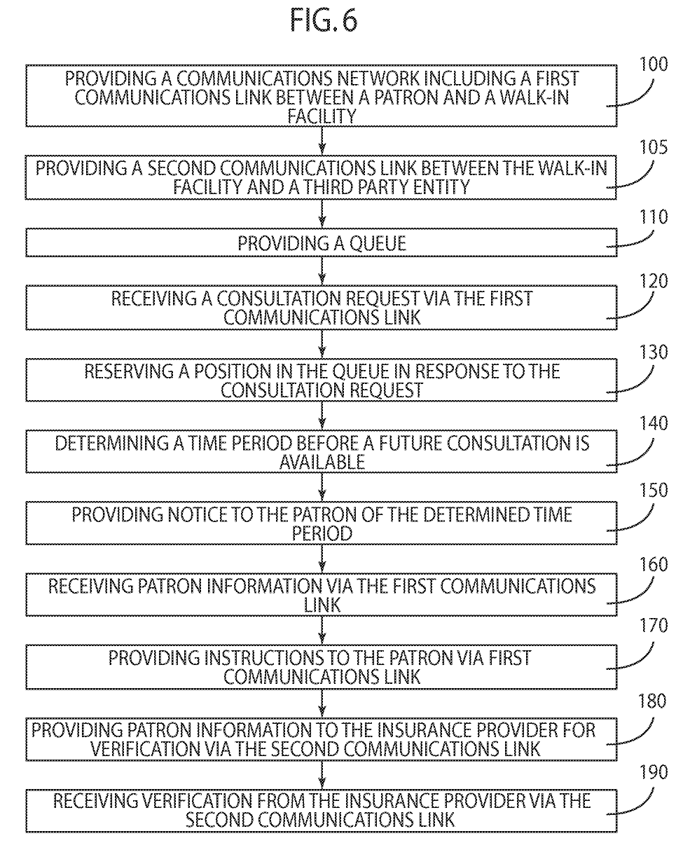

Another embodiment of the inventive method includes additional steps. As shown in FIG. 6, the method of this embodiment further provides second communications link 80 between walk-in facility 50 and third-party entity 60 (step 105). This second communications link 80 may be used for, for example, providing billing and insurance information for verification 86. Walk-in facility 50 may further receive patron information 34, via first communications link 30 (step 160). Patron information 34 may comprise any suitable information communicated by patron 20 to walk-in facility 50.

Typically, patron 20 will receive some response from walk-in facility 50, such as instructions. Instructions 36 may be provided from walk-in facility 50 to patron 20 via first communications link 30 (step 170) and may comprise any suitable information communicated from walk-in facility 50 to patron 20. Walk-in facility 50 may provide patron's information 34 to third-party entity 60 with verification request 82 via second communications link 80 (step 180). Walk-in facility 50 may then receive verification 86 from third-party entity 60, via second communications link 80. (step 190). It should be understood that any appropriate information may be included in steps 150-190, as suited to the needs of patron 20, walk-in facility 50, or third-party entity 60. Accordingly, the above examples of information provided in steps 150-190 are provided for exemplary purposes only and are not intended to limit the scope of the invention.

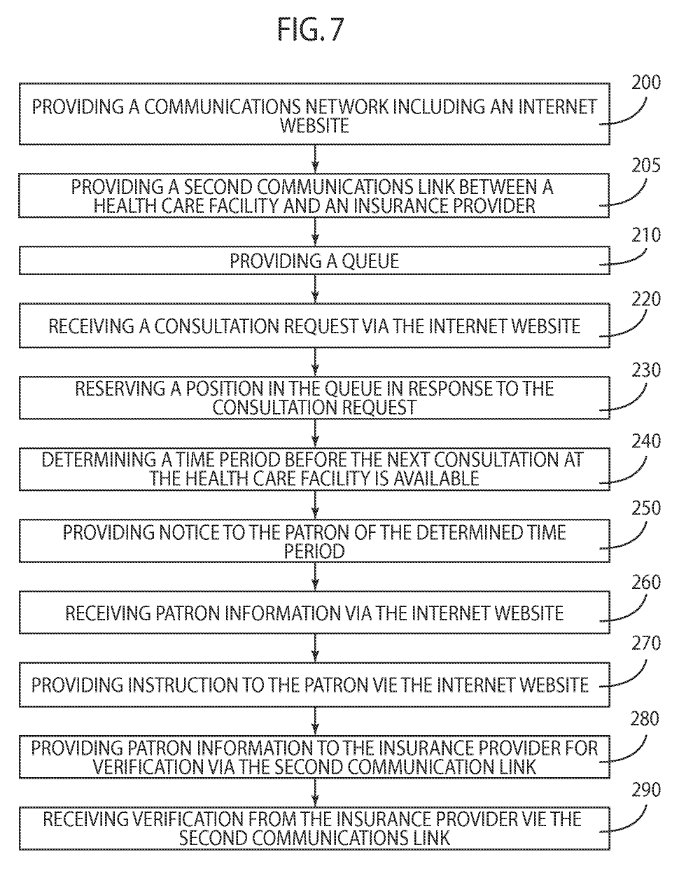

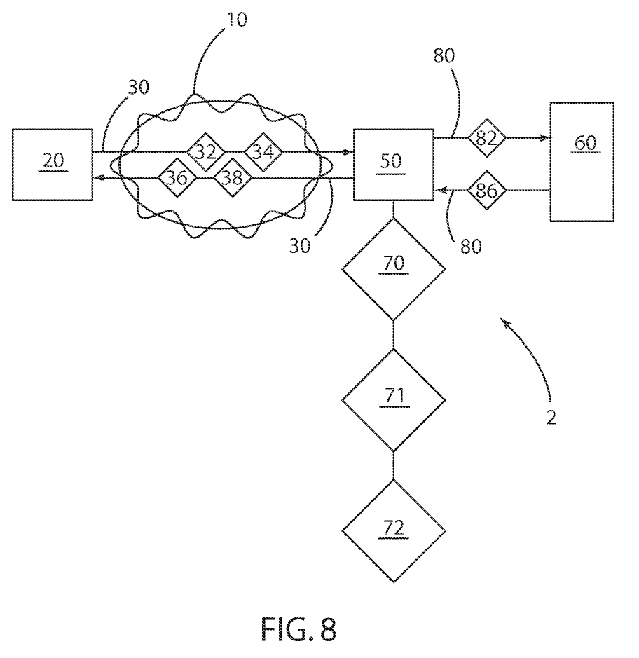

Referring now to FIG. 7 and 8, one embodiment of the inventive method 2 comprises providing communications network 10 including internet website 30 (step 200). Second communications link 80 is provided between health-care facility 50 and insurance provider 60 (step 205). Queue 70 is provided (step 210). In response to consultation request 32 received via internet website 30 (step 220), position 71 in queue 70 is reserved (step 230), the time period 72 before a future consultation is available is determined (step 240), and patron 20 is provided notice 38 of the determined time period 72 (step 250). In regards to step 250, notice 38 may be provided via internet website 30 or by any other suitable communications link. For example, notice 38 may be provided via telephone in lieu of, or in addition to, internet website 30. Patron 20 may wait at a location other than health-care facility 50 during the determined time period 72, thereby reducing patron's 20 need to wait at health-care facility 50 before being consulted at health-care facility 50.

Further, patron information 34 may be received, via internet website 30 (step 260). For example, age, weight, height, prior health conditions, family history, current medications, insurance information, and the like, may be communicated by patron 20 to walk-in facility 50. Of course, this is not meant to be limiting in any manner and patron information 34 may take on numerous configurations, and may be used for numerous purposes as is generally known within the art.

Continuing on then, instructions 36 may be provided from health-care facility 50 to patron 20 (step 270). Instructions 36 may comprise any suitable information communicated from health-care facility 50 to patron 20. For example, instructions 36 may include basic reminders to bring medication information, insurance information. If patron information 34 is provided and indicates a critical or emergency situation, health-care facility 50 may provide instructions 36 to advise patron 20 to report immediately to health-care facility 50, to contact an emergency services provider, and/or may include directions for stabilizing an injury until patron 20 arrives at health-care facility 50. Other types of walk-in facilities, such as an automotive repair shop, may provide other instructions suitable to the situation. For example, instructions 36 may include: where to park the vehicle, which repair records to bring, an overview of the general repair process, or the like.

Health-care facility 50 may provide the patron's information 34 to an insurance provider 60 with a verification request 82 via second communications link 80 (step 280). Health-care facility 50 may receive verification 86 from insurance provider 60, via second communications link 80 (step 290). It should be understood that any appropriate information may be included in steps 250-290, as suited to the needs of patron 20, health-care facility 50, or insurance provider 60. Accordingly, the above examples of information provided in steps 250-290 are provided for exemplary purposes only and are not intended to limit the scope of the invention.

According to one embodiment of the present invention, patron 20's need to wait at health-care facility 50 may be eliminated if time period 72 is determined such that patron 20 reports to health-care facility 50 at the expiration of the determined time period 72 and is immediately consulted. For example, health-care facility 50 provides notice 38 to patron 20 that the determined time period 72 before a consultation is available to patron 20 will be one hour from when notice 38 was provided. If patron 20 reports to health-care facility 50 one hour after notice 38 was provided, patron 20 would inform a receptionist at health-care facility 50 of their arrival and would be immediately escorted or directed to an examination room for consultation.

Although the present invitation is particularly adapted for utilization of an interactive computer network such as the Internet, it shall be apparent to one skilled in the art, given the present disclosure, that communications network 10 is also adapted for utilization of other communications networks and devices including Intranet systems, other client-server networks, personal digital assistant devices, and the like. Similarly, the inventive system and method is equally adapted to other communication environments and in respect to entities other than those described in detail herein. Accordingly, the systems and methods described herein are provided for exemplary purposes only and are not intended to limit the scope of the invention.

Further, the inventive method accomplishes many of the steps herein described simultaneously. As such, the system and method do not necessarily have a linear sequence of events. Therefore, the system and method will be described by reference to the various locations and the steps performed therein. It is also to be understood that various modifications may be made to the system and method's sequences, orientations, and the like without departing from the inventive concept and that the description contained herein is merely a preferred embodiment and hence, not meant to be limiting unless stated otherwise.

The solutions offered by the invention disclosed herein have thus been attained in an economical, practical, and facile manner. To wit, a novel method and system which is time effective and easily utilized has been invented. While preferred embodiments and example configurations of the inventions have been herein illustrated, shown, and described, it is to be appreciated that various changes, rearrangements, and modifications may be made therein, without departing from the scope of the invention as defined by the claims. It is intended that the specific embodiments and configurations disclosed herein are illustrative of the preferred and best modes for practicing the invention, and should not be interpreted as limitations on the scope of the invention as defined by the claims, and it is to appreciated that various changes, rearrangements, and modifications may be made therein, without departing from the scope of the invention as defined by the claims.

The invention claimed is:

1. A method of reducing a patron's waiting time at a walk-in facility, the method comprising:
providing a communications network including a first communications link between a patron and a walk-in facility;
providing a queue;
receiving a consultation request via the first communications link;
reserving a position in the queue in response to the consultation request;
determining a time period before a future consultation is available;
providing notice to the patron of the determined time period;
wherein the patron may wait at a location other than the walk-in facility during the determined time period, thereby reducing the patron's need to wait at the walk-in facility before being consulted at the walk-in facility.

2. The method according to claim 1, wherein the patron is notified of the determined time period via the first communications link.

3. The method according to claim 1, wherein the first communications link comprises an internet website.

4. The method according to claim 1, further comprising:
receiving patron information via the first communications link.

5. The method according to claim 1, further comprising:
providing instructions to the patron via the first communications link.

6. The method according to claim 4, further comprising:
providing a second communications link between the walk-in facility and a third-party entity.

7. The method according to claim 6, further comprising:
providing the patron information to the third-party entity for verification via the second communications link.

8. The method according to claim 7, wherein the patron information includes insurance information.

9. A method of reducing a patron's waiting time at a walk-in facility, the method comprising:
providing a communications network including a first communications link between a patron and a walk-in facility;
providing a second communications link between the walk-in facility and a third party entity;
providing a queue;
receiving a consultation request via the first communications link;
reserving a position in the queue in response to the consultation request;
receiving patron information via the first communications link;
determining a time period before the next consultation is available;
providing notice to the patron of the determined time period;
wherein the patron may wait at a location other than the walk-in facility during the determined time period, thereby reducing the patron's need to wait at the walk-in facility before being consulted at the walk-in facility.

10. The method according to claim 9, wherein the patron is notified of the determined time period via the first communications link.

11. The method according to claim 9, wherein the first communications link comprises an internet website.

12. The method according to claim 9, the method further comprising:
providing instructions to the patron via the first communications link.

13. The method according to claim 9, the method further comprising:
providing the patron information to the third-party entity for verification via the second communications link.

14. The method according to claim 13, the method further comprising:
receiving verification from the third-party entity via the second communications link.

15. The method according to claim 13, wherein the patron information includes insurance information.

16. A method of eliminating a patron's waiting time at a health-care facility, the method comprising:
providing a communications network including an internet website;
providing a second communications link between a health-care facility and an insurance provider;
providing a queue;
receiving a consultation request via the internet website;
reserving a position in the queue in response to the consultation request;
determining a time period before the next consultation at the health-care facility is available, wherein the time period is determined such that the patron may report to the health-care facility at the expiration of the time period and be immediately consulted;
providing notice to the patron of the determined time period;
receiving patron information via the internet website;
providing patron information to the insurance provider for verification via the second communications link;
receiving verification from the insurance provider via the second communications link;
wherein the patron may wait at a location other than the health-care facility during the determined time period, thereby eliminating the patron's need to wait at the health-care facility before being consulted at the health-care facility.

17. The method according to claim 16, the method further comprising:
providing instructions to the patron via the internet website.

18. The method according to claim 16, wherein the notice is provided via the internet website.

19. The method according to claim 16, wherein the second communications link comprises an internet website.

20. The method according to claim 16, wherein the patron information includes insurance information.
